(19) United States
(12) Patent Application Publication
(10) Pub. No.: US 2009/0024803 A1
(43) Pub. Date: Jan. 22, 2009

(54) Multipath accessible semiconductor memory device having shared register and method of operating thereof

(75) Inventors: Jin-Hyoung Kwon, Seongnam-si (KR); Han-Gu Sohn, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/216,188

(22) Filed: Jul. 1, 2008

(30) Foreign Application Priority Data
Jul. 18, 2007 (KR) 10-2007-0071513

(51) Int. Cl. G06F 12/00; G06F 12/02

(52) U.S. Cl. 711/149; 711/147; 711/E12.008; 711/E12.001

(57) ABSTRACT

A semiconductor memory device for use in a multiprocessor system may be provided. A chip size may be controlled, and a design of circuit may be relatively simplified. The semiconductor memory device for use in a multiprocessor system may include at least two shared memory areas commonly accessible by processors of the multiprocessor system through different ports and assigned with a predetermined memory capacity unit to a portion of a memory cell array, a single shared register adapted outside the memory cell array, corresponding to disable areas formed within the shared memory areas, and/or a switching unit for connecting a decoder of a selected shared memory area to the shared register in response to an applied control signal, to match the shared register to the disable area of the selected shared memory area. A shared register may be commonly used in corresponding to a plurality of shared memory areas, thereby reducing or preventing a chip size increase and simplifying a design of the circuit.

### PRIORITY STATEMENT

This application claims priority under 35 U.S.C. §119 from Korean Patent Application 10-2007-0071513, filed on Jul. 18, 2007, the contents of which is hereby incorporated by reference in its entirety.

### BACKGROUND

In general, a semiconductor memory device having a plurality of access ports may be called a multiport memory, and more specifically, a memory device having two access ports may be called a dual-port memory. A typical dual-port memory may be well known in the art, such as an image processing video memory having a Random Access Memory (RAM) port accessible in a random sequence and a Sequential Access Memory (SAM) port accessible only in a serial sequence.

In contrast to the multiport memory described above, a dynamic random access memory (DRAM) accessible to a plurality of processors through a shared memory area having a plurality of access ports, in a memory cell array constructed of a DRAM cell, may be called a multipath accessible semiconductor memory device.

In more recent mobile communication systems, for example, handheld multimedia players, handheld phones, or PDAs, etc., multiprocessor systems employing a plurality of processors adapted in one system have been realized to obtain higher speeds and smoother operation of functions.

In a conventional multiprocessor system, access to a memory area may be shared by a plurality of processors. In this conventional system, a memory array may include first, second and third portions. The first portion may be accessed only by a first processor, the second portion may be accessed only by a second processor, and the third portion may be a shared memory area that may be accessed by both the first and second processors.

In a general multiprocessor system, a nonvolatile memory storing boot codes of a processor, e.g., flash memory, may be adapted to every processor, and a volatile memory, e.g., a DRAM, may also be connected to every corresponding processor. That is, the structure of the DRAM and flash memory may be both adapted to each processor. Thus, the configuration of a multiprocessor system may become increasingly complex, and therefore increase system costs.

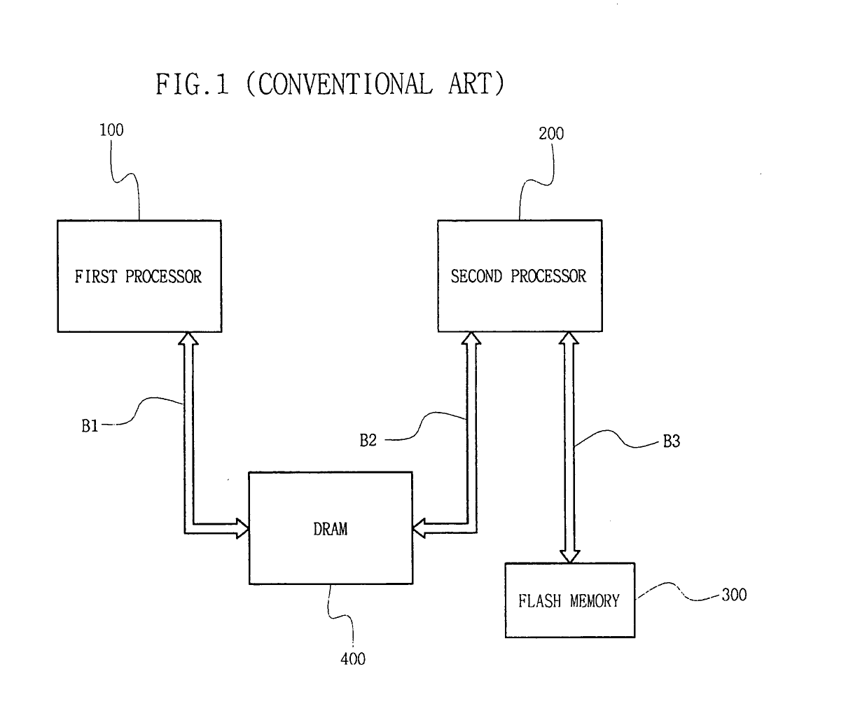

A conventional multiprocessor system adaptable to a mobile communication device is provided as shown in FIG. 1. FIG. 1 is a block diagram schematically illustrating a multiprocessor system having a multipath accessible DRAM.

As shown in FIG. 1, in a multiprocessor system including two or more processors 100 and 200, a DRAM 400 and a flash memory 300 may be shared, and a data interface between processors 100 and 200 may be obtained through the multipath accessible DRAM 400. In FIG. 1, the first processor 100, though not directly connected to the flash memory 300, may indirectly access the flash memory 300 through the multipath accessible DRAM 400.

The first processor 100 may function as a baseband processor performing a determined task, e.g., modulation and demodulation of a communication signal, and the second processor 200 may function as an application processor performing a user convenience function, e.g., dealing with communication data or games, etc., or vice versa. Alternatively, the processors may perform other functions.

The flash memory 300 may be a NOR flash memory having a NOR structure or a NAND flash memory having a NAND structure for a cell array configuration. The NOR flash memory or NAND flash memory may be a nonvolatile memory including a memory cell array which is constructed of a plurality of memory cells. Each of the plurality of memory cells includes a MOS transistor having a floating gate. Such nonvolatile memory may be adapted to retain stored data even if the power is turned off, and may be used to store, for example, boot codes of handheld instruments and preservation data.

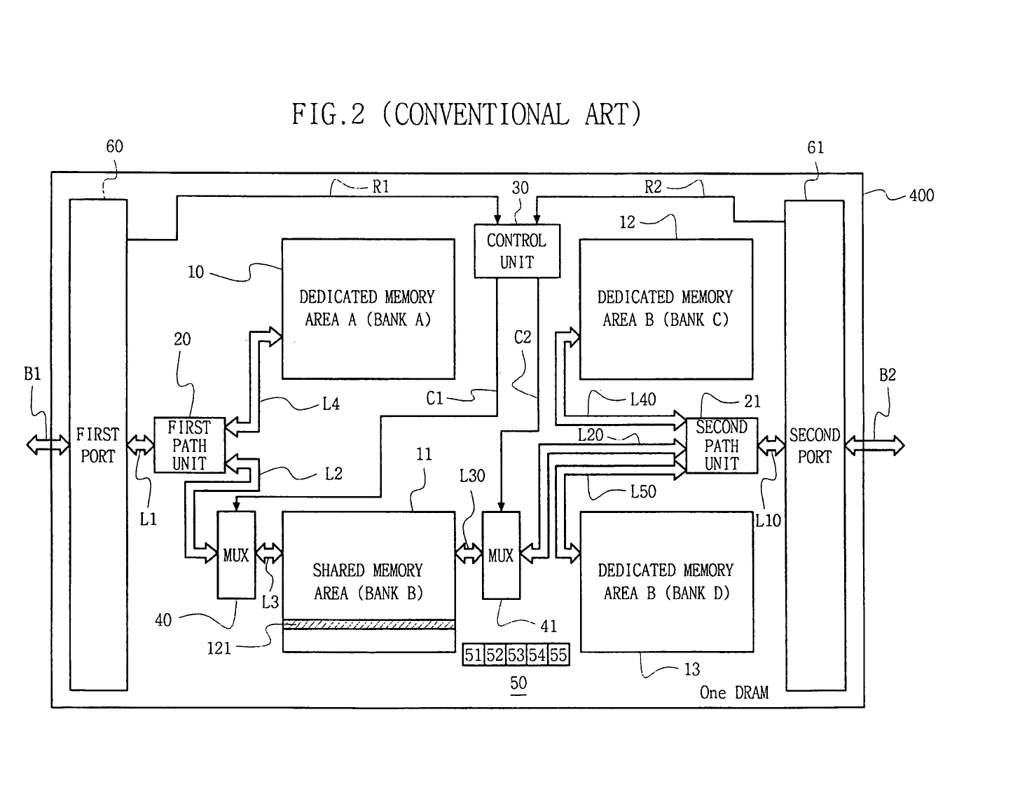

In addition, multipath accessible DRAM 400 may function as a main memory for a data process of processors 100 and 200. As illustrated in FIGS. 1 and 2, the multipath accessible DRAM 400 may be accessed by the first and second processors 100 and 200 through different ports, for example, two ports 60 and 61 connected to corresponding system buses B1 and B2. Such a configuration having a plurality of ports differs from a general DRAM, which has only a single port.

FIG. 2 is a schematic view of a circuit providing operation characteristics of the DRAM 400 shown in FIG. 1.

Referring to FIG. 2, in the multipath accessible DRAM 400, four memory areas 10, 11, 12 and 13 may constitute a memory cell array. For example, a bank A 10 may be accessed dedicatedly by the first processor 100 through the first port 60, and banks C 12 and D 13, may be accessed dedicatedly by the second processor 200 through the second port 61. The bank B 11 may be accessed by both the first and second processors 100 and 200 through the first and second ports 60 and 61. As a result, in the memory cell array, the bank B 11 may be assigned as a shared memory area, and the banks A 10, C 12 and D 13, may be assigned as the dedicated memory areas that may be each accessed only by the corresponding processor. The four memory areas 10-13 may be each constructed of a bank unit of DRAM. A bank unit may have vary in the amount of memory storage, e.g., 64 megabits (Mb), 128 Mb, 256 Mb, 512 Mb, 1024 Mb, etc.

In FIG. 2, internal register 50 may function as an interface unit to provide an interface between the processors 100, 200 so that the internal register 50 may be accessed by both the first and second processors 100 and 200. The internal register 50 may be constructed, for example, of a flip-flop, data latch, SRAM cell or other memory unit known in the art. The internal register 50 may include a semaphore area 51, a first mailbox area 52 (mail box A to B), a second mailbox area 53 (mail box B to A), a check bit area 54, and a reserve area 55. The areas 51-55 may be commonly enabled by their specific row address and/or individually accessed by an applied column address. For example, when a row address 1FFF800h-1FFFFFFh indicating a specific row area 121 of the shared memory area 11 is applied, a portion area 121 of the shared memory area may be disabled, and the internal register 50 may be enabled.

In the semaphore area 51, a term well known in the art, a control authority for the shared memory area 11 may be written, and in the first and second mailbox areas 52 and 53, a message given to a counterpart processor may be written according to a predetermined transmission direction. Messages may include, but are not limited to, an authority request, transmission data such as a logical/physical address of a flash memory, data size or address of a shared memory to store data, commands such as precharge command, etc.

A control unit 30 may control a path to operationally connect the shared memory area 11 to one of the first and second processors 100 and 200. A signal line R1 connected between the first port 60 and the control unit 30 may transfer a first external signal applied through the bus B1 from the first processor 100. A signal line R2 connected between the second port 61 and the control unit 30 may transfer a second external signal applied through the bus B2 from the second processor 200. The first and second external signals may include a row address strobe signal RASB, a write enable signal WEB and/or a bank selection address BA individually applied through the first and second ports 60 and 61. Signal lines C1 and C2 may be respectively connected between the control unit 30 and multiplexers 40 and 41, with each transfer path decision signal MA, MB to operationally connect the shared memory area 11 to the first or second port 60 or 61.

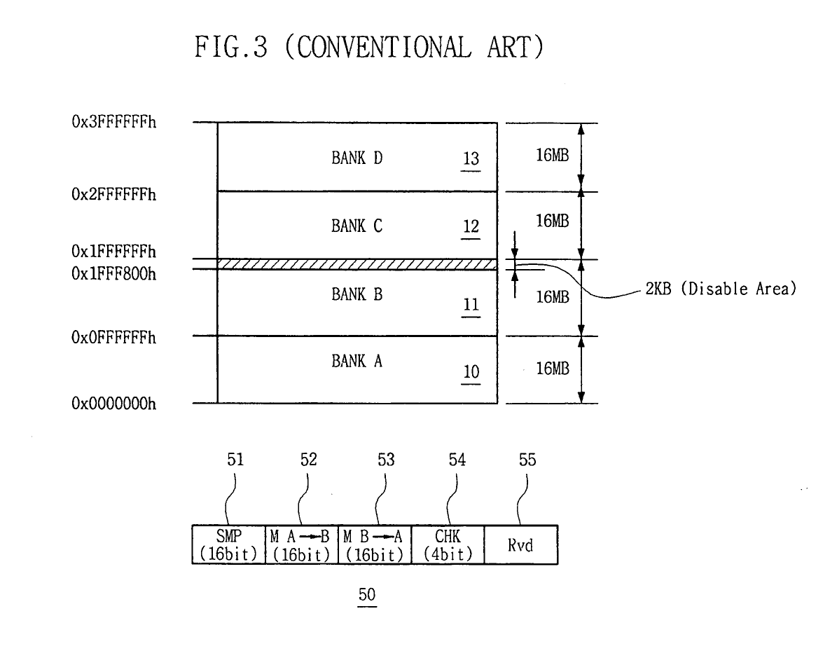

FIG. 3 is a view illustrating an address assignment to access the memory banks 10-13 and internal register 50 of FIG. 2. For example, each bank may have a capacity of 16 megabytes (MB), while 2 kilobytes (KB) of bank B 11, a shared memory area, may be determined to be a disable area. That is, a specific row address (1FFF800h-1FFFFFFh, 2 KB size=1 row size) enabling one optional row of the shared memory area 11 within the DRAM may be changeably assigned to the internal register 50 as the interface unit. Then, when the specific row address (1FFF800h-1FFFFFFh) is applied, a corresponding specific word line 121 of the shared memory area 11 may be disabled, but the internal register 50 may be enabled. As a result, in an aspect of the system, the semaphore area 51 and mailbox areas 52 and 53 may be accessed by using a direct address mapping method, and in a DRAM internal aspect, a command corresponding to a disabled address may be decoded, thus performing a mapping to a register of the DRAM interior. Hence, a memory controller of a chip set may produce a command for this area through the same method as other memory cells. In FIG. 3, the semaphore area 51, the first mailbox area 52 and the second mailbox area 53 may, for example, be each assigned with 16 bits, and the check bit area 54 may be assigned with 4 bits.

In the multiprocessor system of FIG. 1 that includes a DRAM 400 having a shared memory area, as described above in FIGS. 2 and 3, a DRAM and/or flash memory may be commonly used without having to be assigned to every processor, thus the size and complexity of a system and the number of memories may be reduced.

The conventional multipath accessible DRAM 400 shown in FIG. 1 may be, for example, a DRAM marketed as oneDRAM®. The DRAM 400 may be a fusion memory chip that may increase a data processing speed between a communication processor and a media processor in a mobile device. In general, two processors require two memory buffers. But the DRAM 400 may route data between processors through a single chip, thus reducing or eliminating the need for two memory buffers. The DRAM 400 may reduce the time taken in transmitting data between processors by employing a dual-port approach. A DRAM 400 may replace at least two mobile memory chips within a high-performance smart-phone and other multimedia rich-handset. As the data processing speed between processors increases, DRAM 400 may reduce power consumption (up to 30 percent) and the number of chips needed, as well as reduce the total die area coverage (up to 50 percent) compared to other memory chips known in the art. As a result, the speed of cellular phone may increase (up to five times), battery life may be prolonged, and handset designs may become slimmer.

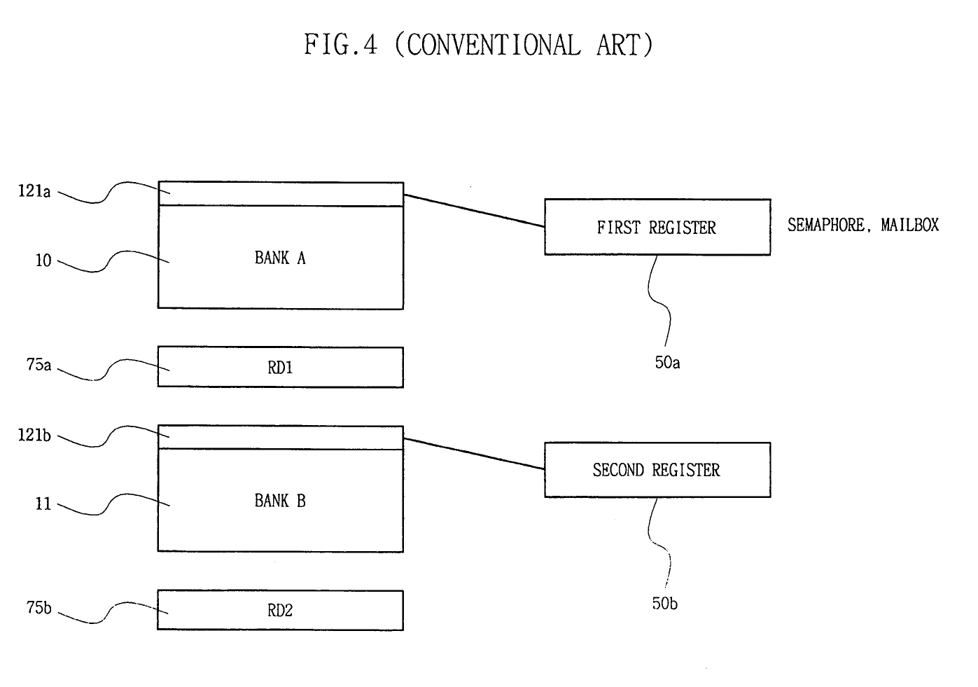

In the multiprocessor system of FIG. 1, which shares the multipath accessible DRAM 400 and the flash memory 300, additional shared memory areas may be employed, as shown in FIG. 4.

FIG. 4 is a layout illustrating a plurality of registers corresponding to respective banks in a conventional multi-shared memory bank structure. With reference to FIG. 4, a plurality of shared memory areas 10 and 11 and their corresponding registers 50a and 50b may be disposed. In more detail, when a row address to access a disable area 121a of the bank A 10 is applied, a row decoder RD1 may disable the disable area 121a and enable the first register 50a. The first register 50a may be a data latch device including a semaphore/mailbox. On the other hand, when the bank B 11 is selected and a row address to access a disable area 121b of the bank B 11 is applied, a row decoder RD2 may disable the disable area 121b and enable the second register 50b.

As a result, FIG. 4 provides, as an example, two or more banks designed as shared memory areas to increase a memory capacity, unlike FIG. 2, which shows only one shared memory area 11. In such a multi-shared memory bank structure, registers necessary for an access authority transfer and precharge may be disposed corresponding to the number of shared memory areas. Thus, in using the same number of registers as the number of banks having shared memory areas, the chip size and complexity may increase and complications in circuit design may result.

### SUMMARY

According to example embodiments, a semiconductor memory device may have one shared register corresponding to multiple shared memory areas.

Example embodiments may provide a semiconductor memory device for use in a multiprocessor system, to reduce the number of registers.

Example embodiments may provide a semiconductor memory device and/or a shared register operating method thereof, which may be capable of using a commonly shared register, regardless of the number of banks in shared memory areas, to perform an interface between processors.

Example embodiments may provide a multipath accessible semiconductor memory device and/or a shared register operating method thereof, using a single register disposed within a chip, thereby limiting a chip size increase and/or simplifying a circuit design.

According to example embodiments, a semiconductor memory device for use in a multiprocessor system may have at least two shared memory areas, a shared register corresponding to disable areas formed within each of the at least two shared memory areas, and/or a switching unit for connecting a decoder of a selected shared memory area to the shared register in response to an applied control signal, to match the shared register to the disable area of the selected shared memory area. The at least two shared memory areas may be commonly accessible by at least two processors through different ports, the at least two memory areas each having a memory capacity unit assigned form a portion of a memory cell array. The shared register may be adapted outside the memory cell array.

The control signal may be a mode register set signal or extended mode register set signal.

The shared register may include a semaphore area and/or a plurality of mailbox areas individually accessible by a column address. The shared memory area may include DRAM cells and/or the shared register may include a flip-flop circuit.

The shared register may be accessed corresponding to a specific row address of the shared memory area, and/or the memory cell array may further include dedicated memory areas dedicatedly accessible by one of the respective processors. The memory capacity unit may be a memory bank unit.

The switching unit may include a multiplexer and/or the extended mode register set signal may be a signal determined by two bits, generally centrally located in an applied address.

According to example embodiments, a semiconductor memory device for use in a multiprocessor system may include a plurality of shared memory areas, a shared register corresponding to disable areas formed within each of the plurality of shared memory areas, and/or a multiplexer for connecting a row decoder of a selected shared memory area to the shared register in response to an applied external control signal, to match the shared register to a disable area of the shared memory area selected from the plurality of shared memory areas. The plurality of shared memory areas may be commonly accessible by at least two processors through different ports, the plurality of memory areas each having a memory capacity unit assigned from a portion of a memory cell array. The shared register may be adapted outside the memory cell array. The plurality of shared memory areas may include first, second, third and fourth shared memory areas

According to example embodiments, a multiprocessor system may include at least two processors each performing a task, a nonvolatile semiconductor memory connected to one of the at least two processors, and/or a semiconductor memory device including at least two shared memory areas, a shared register corresponding to disable areas formed within the at least two shared memory areas, and/or a switching unit for connecting a decoder of a selected shared memory area to the shared register in response to an applied control signal to match the shared register to a disable area of the selected shared memory area. The at least two shared memory areas may be commonly accessible by the at least two processors through different ports, the at least two shared memory areas each having a memory capacity unit assigned from a portion of a memory cell array. The shared register may be adapted outside the memory cell array. The nonvolatile semiconductor memory may be a NAND flash memory and/or store a boot code of the at least two processors. The system may be a portable multimedia device.

According to example embodiments, a method of operating a register for performing a data interface between processors, in a semiconductor memory device may include preparing a shared register corresponding to disable areas formed within at least two shared memory areas, and/or receiving an external control signal and/or switching a decoder of a selected shared memory area to the shared register, to enable the shared register instead of the corresponding selected shared memory when an address designating a disable area of a selected shared memory area is applied. The at least two shared memory areas may be commonly accessible by at least two processors through different ports, the at least two shared memory areas each having a memory capacity unit assigned from a portion of a memory cell array. The shared register may be adapted outside the memory cell array. The external control signal may be a mode register set signal or extended mode register set signal.

In the device and/or method according to example embodiments, a shared register is commonly used corresponding to a plurality of shared memory areas, thereby controlling a chip size increase and simplifying a design of circuit.

### BRIEF DESCRIPTION

The above and other features and advantages will become more apparent by describing in detail example embodiments thereof with reference to the attached drawings in which:

FIG. 1 is a block diagram schematically illustrating a conventional multiprocessor system;

FIG. 2 is a schematic diagram providing operation characteristics of a DRAM of FIG. 1;

FIG. 3 is a view illustrating an address assignment to access memory banks and a register of FIG. 2;

FIG. 4 is a layout illustrating a plurality of registers disposed corresponding to respective banks in a conventional multi-shared memory bank structure;

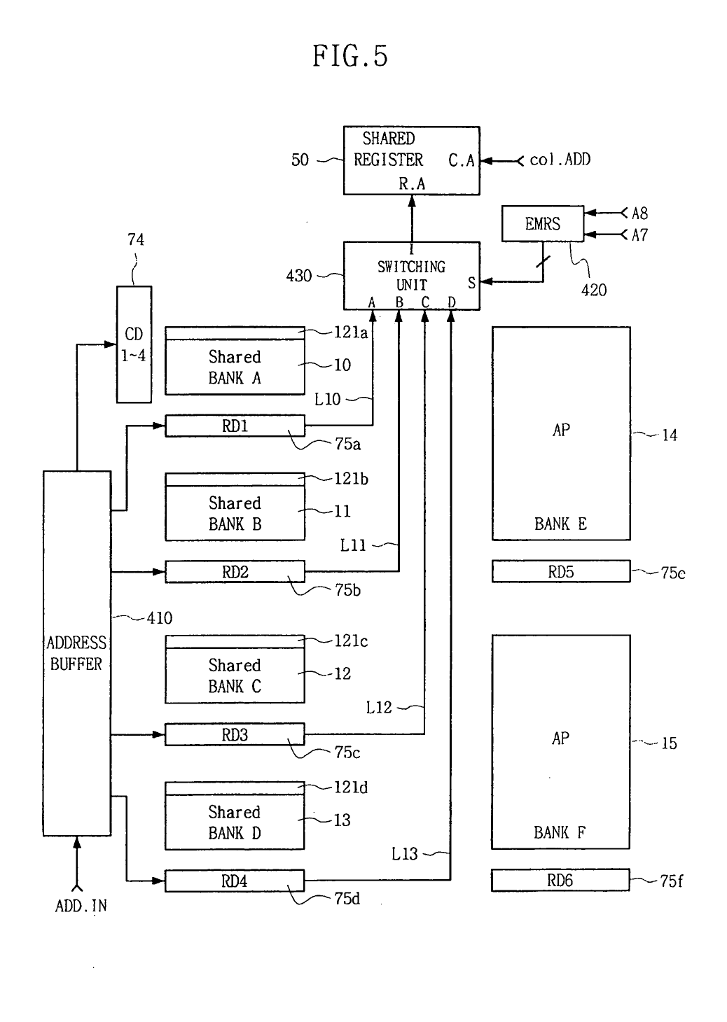

FIG. 5 is a block diagram of circuit including a shared register in a multi-shared memory bank structure according example embodiments;

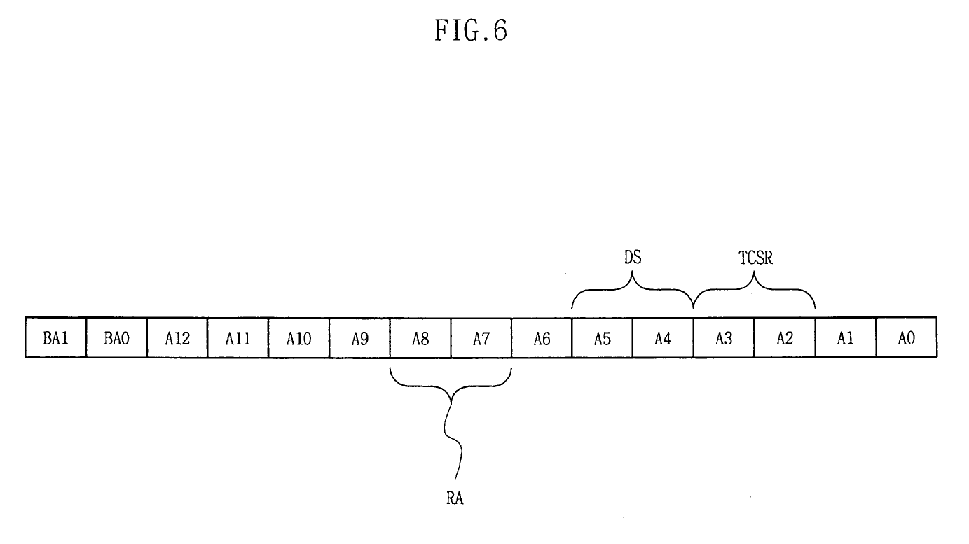

FIG. 6 is an enlarged view illustrating an address signal applied to an extended mode register set of FIG. 5;

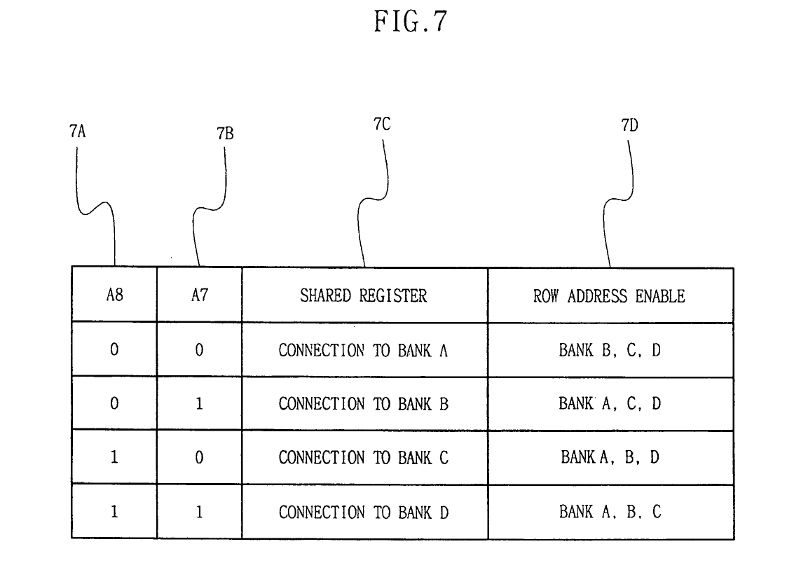

FIG. 7 is a table illustrating a connection between a shared register and a bank through an extended mode register set signal referred to in FIG. 6; and

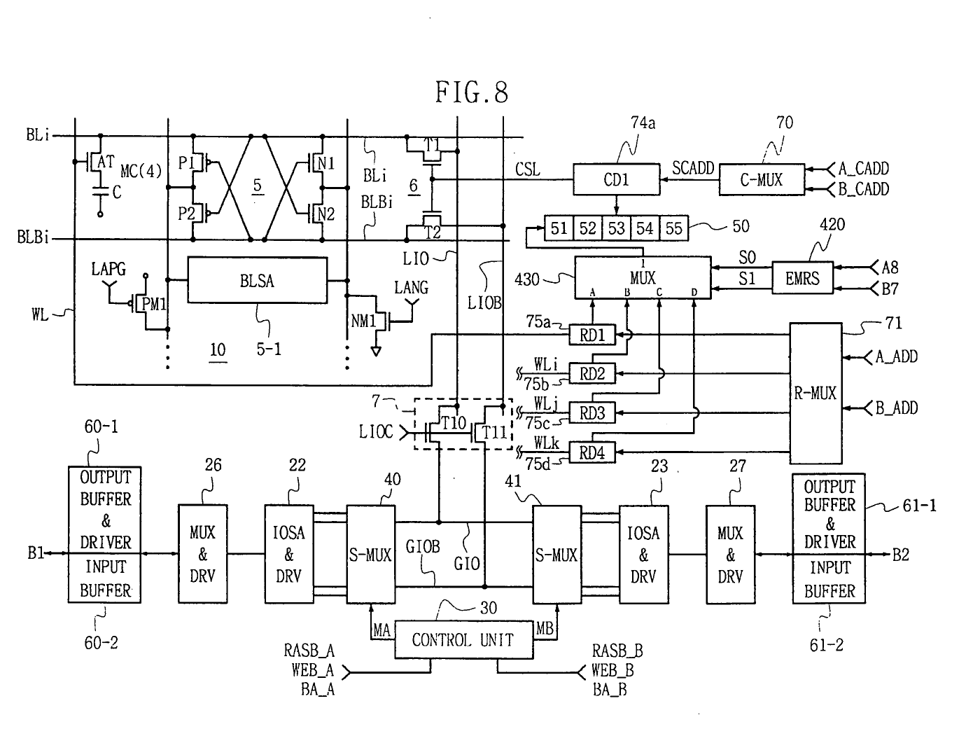

FIG. 8 is a block diagram of a semiconductor memory device, illustrating a multipath access to a shared memory area, according to example embodiments.

### DETAILED DESCRIPTION

Example embodiments will now be described more fully hereinafter with reference to FIGS. 5 to 8. Example embodiments may, however, be embodied in many different forms and should not be construed as limited to example embodiments set forth herein. Rather these example embodiments are provided so that this disclosure will be thorough and complete, and will fully convey the scope of example embodiments to those skilled in the art.

It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belongs. It will be further understood that terms used herein should be interpreted as having a meaning that is consistent with their meaning in the context of this specification and the relevant art and will not be interpreted in an idealized or overly formal sense unless expressly so defined herein. For purposes of clarity, a detailed description for other examples, publication methods, procedures, general dynamic random access memories and circuits, as known in the art, has been omitted.

A multipath accessible semiconductor memory device having a shared register and a shared register operating method thereof are described according to example embodiments, as follows.

According to example embodiments, a semaphore/mailbox register for a DRAM, for example, a DRAM marketed as oneDRAM®, having a plurality of shared memory areas may be commonly used through a switching operation, thereby achieving greater control of chip size and a simplification of design.

FIG. 5 is a block diagram of circuit including a shared register in a multi-shared memory bank structure according to example embodiments.

Referring to FIG. 5, at least two shared memory areas may be assigned with a predetermined memory capacity unit to a portion of memory cell array. That is, of six banks, four banks may be shared memory areas 10, 11, 12 and 13, and two banks may be dedicated memory areas 14 and 15. A capacity of the dedicated memory area 14 may be twice a capacity of the shared memory area 10 but other memory capacity sizes may also be possible.

The six banks 10-15 may be disposed to individually correspond to respective row decoders. Six row decoders 75a-75f may be adapted to respectively correspond to the six banks 10-15. Disable areas (or data transfer areas) 121a-121d, may be formed within the shared memory areas 10, 11, 12 and 13.

When an address is input to an address buffer 410, a row address may be applied to the row decoders 75a-75d, and a column address may be input to column decoder 74.

Generally, an even number of banks may be adopted for the shared memory areas 10-13. A shared register 50 may be commonly connected with the four row decoders 75a-75d through a switching unit 430. The shared register 50 may be positioned outside the memory cell array so as to provide a data interface function between the processors, and may be constructed of a data storage circuit, such as a latch.

When the bank A 10 is selected and a row address to access the data transfer area 121a is applied, the data transfer area 121a may be disabled and the shared register 50 may be enabled. When the bank B 11 is selected and a row address to access the data transfer area 121b is applied, the data transfer area 121b may be disabled and the shared register 50 may be enabled. When the bank C 12 is selected by a bank address and a row address to access the data transfer area 121c is applied, the data transfer area 121c may be disabled and the shared register 50 may be enabled. When the bank D 13 is selected and a row address to access the data transfer area 121d is applied, the data transfer area 121d may be disabled and the shared register 50 may be enabled.

The shared register 50 may be shared by the four shared memory areas 10-13, thereby allowing a reduction of chip size and design simplification.

The switching unit 430 may connect the shared register 50 to a row decoder selected from the four row decoders 75a-75d in response to an extended mode register set (EMRS) signal of an EMRS circuit 420.

The banks in FIG. 5 may have a storage capacity of 512 Mb, where four of the six banks may be shared memory banks, and the remaining two banks may be dedicated access areas of the second processor 200. However, various other memory capacity sizes may also be possible.

Accordingly, there may be adapted a single shared register 50 that may be adapted outside the memory cell array, corresponding to the disable areas of the shared memory areas; and/or a switching unit 430 for connecting a decoder of a selected shared memory area to the shared register 50 in response to an applied control signal EMRS, to match the shared register to a disable area of the selected shared memory area, thereby reducing or lessening the number of shared registers needed.

FIG. 6 is an enlarged view illustrating an address signal applied to an EMRS of FIG. 5, and provides, as an example, an address signal formatted and applied to have a bank address of two bits and a row address of thirteen bits. The EMRS signal may be loaded at the eighth and ninth address bits A7 and A8, provided as reserved areas, and thus one of the four banks may be selected and a row decoder corresponding to the bank may be switched. In FIG. 6, a reference character RA may indicate a register assignment. Reference characters DS and TCSR are well known designations in a general EMRS.

FIG. 7 is a table illustrating a connection between a shared register and a bank through an EMRS signal referred to in FIG. 6. Reference characters 7A and 7B may each indicate a logic state of ninth and eighth address bits A8 and A7, and 7C and 7D may each indicate a connected state between the bank and the shared register, with the non-selected banks not having a disable area.

In FIG. 7, for example, when a power-up operation is performed in a multiprocessor system and the ninth and eighth address bits A8 and A7 are applied as “00”, the first row decoder 75a of the bank A 10 in FIG. 5 may be coupled to the shared register 50 through a line L10. In this case, the data transfer areas 121b, 121c and 121d of the banks B 11, C 12 and D 13 may be used as a normal memory area without being disabled.

When the ninth and eighth address bits A8 and A7 are applied as “01”, the second row decoder 75b of the bank B 11 in FIG. 5 may be coupled to the shared register 50 through a line L11. In this case, the data transfer areas 121a, 121c and 121d of the banks A 10, C 12 and D 13 may be used as a normal memory area without being disabled.

When the ninth and eighth address bits A8 and A7 are applied as “10”, the third row decoder 75c of the bank C 12 in FIG. 5 may be coupled to the shared register 50 through a line L12. In this case, data transfer areas 121a, 121b and 121d of the banks A 10, B 11 and D 13 may be used as a normal memory area without being disabled.

When the ninth and eighth address bits A8 and A7 are applied as “11”, the fourth row decoder 75d of the bank D 13 in FIG. 5 may be coupled to the shared register 50 through a line L13. In this case, data transfer areas 121a, 121b and 121c of the banks A 10, B 11 and C 12 may be used as a normal memory area without being disabled.

FIG. 8 is a block diagram of semiconductor memory device, illustrating a multipath access to a shared memory area 10.

With reference to FIG. 8, a row address multiplexer 71 may select and output one of an output address A_ADD applied from an address buffer of port A and an output address B_ADD applied from an address buffer of port B. First row decoder 75a may correspondingly connect to the bank A 10 of FIG. 5, and may perform a row decoding on the bank A 10 in response to an output row address of the row address multiplexer 71. Second row decoder 75b, may connect correspondingly to the bank B 11 of FIG. 5, and may perform a row decoding on the bank B 11 in response to an output row address of the row address multiplexer 71. Third row decoder 75c may correspondingly connect to the bank C 12 of FIG. 5, and may perform a row decoding on the bank C 12 in response to an output row address of the row address multiplexer 71. Fourth row decoder 75d may correspondingly connect to the bank D 13 of FIG. 5, and may perform a row decoding on the bank D 13 in response to an output row address of the row address multiplexer 71.

A method of connecting a shared memory area to one of two selected ports may be described in detail as follows, with reference to FIG. 8.

Referring to FIG. 8, a register 50 may correspond to the shared register 50 shown in FIG. 5, disposed outside a memory cell array. A semiconductor memory device shown in FIG. 8 may have two independent ports. The internal register 50 functioning as an interface unit to provide an interface between processors may be accessed by both the first and second processors 100 and 200, and may for example, be constructed of a flip-flop, data latch or SRAM cell. The internal register 50 may include a semaphore area 51, a first mailbox area (mail box A to B) 52, a second mailbox area (mail box B to A) 53, a check bit area 54, and a reserved area 55.

A second multiplexer 40 for a port A and a second multiplexer 41 for a port B may be disposed symmetrically on the shared memory area 10, and an input/output sense amplifier and driver 22 and an input/output sense amplifier and driver 23 may be disposed symmetrically on the shared memory area 10. Within the shared memory area 10, a DRAM cell 4 constructed of one access transistor AT and a storage capacitor C may form a unit memory device. The DRAM cell 4 may be connected with intersections of a plurality of word lines and a plurality of bit lines, thus forming a bank array type matrix. A word line WL shown in FIG. 8 may be disposed between a gate of access transistor AT of the DRAM cell 4 and a first row decoder 75a. The first row decoder 75a may generate a row decoded signal in response to an output row address of row address multiplexer 71, and may apply the signal to the word line WL or the register 50. A bit line BLi constituting a bit line pair may be coupled to a drain of the access transistor AT and a column selection transistor T1. A complementary bit line BLBi may be coupled to a column selection transistor T2. PMOS transistors P1 and P2 and NMOS transistors N1 and N2 may be coupled to the bit line pair BLi, BLBi constituting a bit line sense amplifier 5. Sense amplifier driving transistors PM1 and NM1 may each receive a drive signal LAPG, LANG, and drive the bit line sense amplifier 5. A column selection gate 6 constructed of column selection transistors T1 and T2 may be coupled to a column selection line CSL transferring a column decoded signal of a column decoder 74a. The column decoder 74a may apply a column decoded signal to the column selection line and the register 50 in response to a selection column address SCADD of a column address multiplexer 70.

In FIG. 8, a local input/output line pair LIO, LIOB may be coupled to a first multiplexer 7. When transistors T10 and T11 constituting the first multiplexer 7, F-MUX are turned on in response to a local input/output line control signal LIOC, the local input/output line pair LIO, LIOB may be coupled to a global input/output line pair GIO, GIOB. Then, data of the local input/output line pair LIO, LIOB may be transferred to the global input/output line pair GIO, GIOB in a read operating mode of data. On the other hand, write data applied to the global input/output line pair GIO, GIOB may be transferred to the local input/output line pair LIO, LIOB in a write operating mode of data. The local input/output lien control signal LIOC may be a signal generated in response to a decoded signal output from the row decoder 75a.

When a path decision signal MA output from a control unit 30 has an active state, read data transferred to the global input/output line pair GIO, GIOB may be transferred to the input/output sense amplifier and driver 22 through the second multiplexer 40. The input/output sense amplifier 22 may amplify data having weakened levels from being transferred through the data paths. The read data output from the input/output sense amplifier 22 may be transferred to first port 60-1 through multiplexer and driver 26. Meanwhile, the path decision signal MB may be under an inactive state, thus the second multiplexer 41 may be disabled. Also, an access operation of the second processor 200 to the shared memory area 10 may be intercepted. However, in this case, the second processor 200 may access dedicated memory areas 12 and 13, but not the shared memory area 11, through the second port 61-1.

When the path decision signal MA output from the control unit 30 is under the active state, write data applied through first port 60-2 may be transferred to the global input/output line pair GIO, GIOB, sequentially passing through the multiplexer and driver 26, the input/output sense amplifier and driver 22 and the second multiplexer 40. When the first multiplexer 7, F-MUX is activated, the write data may be transferred to local input/output line pair LIO, LIOB and then stored in a selected memory cell 4.

An output buffer and driver 60-1 and input buffer 60-2 shown in FIG. 8 may correspond to or be included in the first port 60 of FIG. 2. The two input/output sense amplifiers and drivers 22 and 23 may be adapted accordingly. The second multiplexers 40 and 41 may have a mutually complementary operation to prevent two processors from simultaneously accessing the data of the shared memory area 11.

The first and second processors 100 and 200 may commonly use circuit devices and lines that are adapted between the global input/output line pair GIO, GIOB and the memory cell 4 in an access operation, and independently use input/output related circuit devices and lines between each port and the second multiplexer 40, 41.

In more detail, the first and second processors 100 and 200 may respectively share through the first and second ports 60 and 61, the following: the global input/output line pair GIO, GIOB of the shared memory area 11; the local input/output line pair LIO, LIOB operationally connected to the global input/output line pair; the bit line pair BL, BLB operationally connected to the local input/output line pair through the column selection signal CSL; the bit line sense amplifier 5 adapted on the bit line pair BL, BLB, to sense and amplify data of a bit line; and the memory cell 4 having an access transistor AT connected to the bit line BL.

As described above, in a semiconductor memory device of example embodiments having a detailed configuration as shown in FIG. 8, an interface function between the processors 100 and 200 may be attained. The processors 100 and 200 may perform data communication through the commonly accessible shared memory area by using the internal register 50 functioning as an interface unit, and also a precharge skip problem may be solved in an access authority transfer.

In example embodiments, a shared register 50 may be disposed and selectively coupled to one of the four row decoders 75a-75d through a multiplexing operation of the multiplexer 430 that functions as a switching unit. The multiplexer 430 may be controlled in response to an output signal S0, S1 of the EMRS circuit 420. The output signal S0, S1 may be a signal generated by the extended mode register circuit 420 that receives two generally central bits A8 and A7 of an applied address and then generates the signal. The multiplexer 430 may be described above as four-input multiplexer, but may also vary to have more or less inputs or outputs.

In a semiconductor memory device including at least two or more shared memory areas that may be commonly accessed through different ports by processors of a multiprocessor system and that may be assigned with a predetermined memory capacity unit to a portion of a memory cell array, a method of operating a register to perform a data interface between the processors may be described as follows.

First, a shared register may be adapted outside the memory cell array, corresponding to disable areas of the shared memory areas. Then, to enable the shared register corresponding thereto when an address designating a disable area of a selected shared memory area of the shared memory areas is applied, an external control signal such as a mode register set or EMRS, etc., may be received to switch a decoder of the selected shared memory area to the shared register. Accordingly, an operation of the DRAM may be realized even with a shared register in a multi-shared memory bank structure.

In a multiprocessor system applied to example embodiments, the number of processors may increase to three or more. In the multiprocessor system, the processor may be a microprocessor, CPU, digital signal processor, micro controller, reduced command set computer, complex command set computer, or the like. But it may be understood that the scope of example embodiments may not be limited to the number of processors in the system. Further, the scope of example embodiments may not be limited to any special combination of processors in adapting the same or different processors as the embodiments described above.

For example, of six memory areas, two may be designated as shared memory areas and the remaining four may be designated as dedicated memory areas. Alternatively, three memory areas each may be respectively determined as shared memory areas and dedicated memory areas. In addition, though the system employing two processors may be described above as the example, in employing three or more processors in the system, three or more ports may be adapted in one DRAM and one of three processors may access a predetermined shared memory at a specific time. Furthermore, although DRAM is described above in example embodiments, example embodiments may also be extended to various types of static random access memory or nonvolatile memory, etc.

As described above, according to example embodiments, one shared register may be commonly used by a plurality of shared memory areas, thereby limiting or reducing a chip size increase and simplifying a design of the circuit.

It will be apparent to those skilled in the art that modifications and variations may be made to example embodiments without deviating from the spirit or scope of example embodiments. Thus, it is intended that example embodiments may cover any such modifications and variations, provided they come within the scope of the appended claims and their equivalents. For example, details in a switching unit, or configuration of a shared memory bank or circuit, and an access method may vary. Accordingly, these and other changes and modifications are seen to be within the true spirit and scope of example embodiments, as defined by the appended claims.

In the drawings and specification, there have been disclosed example embodiments and, although specific terms are employed, they are used in a generic and descriptive sense only and not for purposes of limitation, the scope of the invention being set forth in the following claims.

What is claimed is:

1. A semiconductor memory device for use in a multiprocessor system, the device comprising:
at least two shared memory areas;
a shared register corresponding to a disable area within each of the at least two shared memory areas; and
a switching unit for connecting a decoder of a selected shared memory area to the shared register in response to an applied control signal, to match the shared register to the disable area of the selected shared memory area.

2. The device of claim 1, where the at least two shared memory areas are commonly accessible by at least two processors through different ports, the at least two shared memory areas each having a memory capacity unit assigned from a portion of a memory cell array.

3. The device of claim 2, further comprising:
at least one dedicated memory area having a memory capacity unit assigned from a portion of the memory cell array, each of the at least one dedicated memories dedicatedly accessible by a respective one of the at least two processors.

4. The device of claim 2, wherein the shared register is adapted outside the memory cell array.

5. The device of claim 2, wherein the memory capacity unit is a memory bank unit.

6. The device of claim 1, wherein the control signal is a mode register set signal.

7. The device of claim 1, wherein the control signal is an extended mode register set signal.

8. The device of claim 7, wherein the extended mode register set signal is determined by at least one bit of an applied address.

9. The device of claim 8, wherein the at least one bit includes two centrally located bits in the applied address.

10. The device of claim 1, wherein the shared register includes a semaphore area and a plurality of mailbox areas individually accessible by a column address.

11. The device of claim 1, wherein the at least two shared memory areas include DRAM cells and the shared register includes a flip-flop circuit.

12. The device of claim 1, wherein the shared register is accessed corresponding to a specific row address of each of the at least two shared memory areas.

13. The device of claim 1, wherein the switching unit includes a multiplexer.

14. The device of claim 1, wherein the decoder is a row decoder and the control signal is an external control signal.

15. The device of claim 1, wherein the at least two shared memory areas include first, second, third and fourth shared memory areas.

16. The device of claim 1, wherein the shared register includes a data storage circuit of latch type.

17. A multiprocessor system comprising:
at least two processors each performing a task;
a nonvolatile semiconductor memory connected to one of the at least two processors; and
the semiconductor memory device of claim 1.

18. The system of claim 17, where the at least two shared memory areas are commonly accessible by the at least two processors through different ports, the at least two shared memory areas each having a memory capacity unit assigned from a portion of a memory cell array.

19. The system of claim 18, wherein the shared register is adapted outside the memory cell array.

20. The system of claim 17, wherein the nonvolatile semiconductor memory is a NAND flash memory and stores a boot code of the at least two processors.

21. The system of claim 17, wherein the system is a portable multimedia device.

22. A method of operating a register for performing a data interface between processors, in a semiconductor memory device, the method comprising:
providing a shared register corresponding to disable areas formed within at least two shared memory areas; and
receiving an external control signal and switching a decoder of a selected shared memory area to the shared register, to enable the shared register instead of the corresponding selected shared memory when an address designating a disable area of a selected shared memory area is applied.

23. The method of claim 22, where the at least two shared memory areas are commonly accessible by at least two processors through different ports, the at least two shared memory areas each having a memory capacity unit assigned from a portion of a memory cell array.

24. The method of claim 23, wherein the shared register is adapted outside the memory cell array.

25. The method of claim 22, wherein the external control signal is a mode register set signal or extended mode register set signal.
